(19) United States
(12) Patent Application Publication
(10) Pub. No.: US 2022/0351077 A1
(43) Pub. Date: Nov. 3, 2022

(54) Artificial Intelligence Assisted Editor Recommender

(71) Applicant: American Chemical Society, Washington, DC (US)

(72) Inventors: Yinghao Ma, Potomac, MD (US); Sonja Krane, Blue Bell, PA (US); Eric Mills, Reston, VA (US); Jofia Jose Prakash, Aldie, VA (US); Utpal Tejookaya, Springfield, VA (US); Emine Oymak, Germantown, MD (US); Aarthii Deenadayalan, Herndon, VA (US); Laura Fernandez, Woodbridge, VA (US); Jeroen Van Prooijen, Fairfax, VA (US); Jonathan Hansford, Burke, VA (US); Jinglei Li, Falls Church, VA (US); Wallace Scott, Fairfax Station, VA (US)

(73) Assignee: American Chemical Society, Washington, DC (US)

(21) Appl. No.: 17/733,197

(22) Filed: Apr. 29, 2022

Related U.S. Application Data
(60) Provisional application No. 63/181,516, filed on Apr. 29, 2021.

(51) Int. Cl. G06N 20/00; G06F 16/23

(52) U.S. Cl. CPC G06N 20/00; G06F 16/23

(57) ABSTRACT

A method is disclosed, involving converting at least one structured text document stored in a database into one or more vectors, training a machine learning model to associate the at least one vector with the editors for that structured text document, training a machine learning model to associate the at least one vector with the editors for that structured text document, receiving a second structured text document and converting said second structured text document into one or more vectors, then processing the one or more vectors of the unpublished structured text documents through the trained machine learning model to identify appropriate editor teams, before finally sending the unpublished structured text documents to a computer device associated with an editor.

### CROSS-REFERENCE TO RELATED APPLICATIONS

This application claims priority to provisional patent application No. 63/181,516, filed Apr. 29, 2021.

### BACKGROUND

### Field

Embodiments of the present disclosure relate to Artificial Intelligence Tools for recommending editors for structured text documents.

### Description of Related Art

Before the advent of modern machine learning, the editor selection process could be assisted only minimally by computers. Assigning editors for submissions to scientific or academic journals or requires both knowing which editor to assign to which article, while also ensuring workloads are balanced across different editors. The task is complicated by journals that have different editor structurers and hierarchies between executive editors and associate editors. Therefore, there is a need for improved methods for leveraging machine learning to improve existing tools for recommending and assigning editors for scientific or academic journal submissions.

### SUMMARY

One aspect of the present disclosure is directed to a method for recommending editors for structured text documents. The method comprises, for example, converting at least one structured text document stored in a database into one or more vectors, each structured text document having a title, an abstract, and editor information. The method further comprises, for example, training a machine learning model to associate the at least one vector with the editor information for that structured text document. The method further comprises, for example, receiving an additional structured text document, having a title, an abstract. The method further comprises, for example, converting said additional structured text document into one or more vectors. The method further comprises, for example, processing the one or more vectors of the unpublished structured text documents through the trained machine learning model to identify appropriate editor teams. The method further comprises, for example, distributing the additional structured text document to an editor on the appropriate editor team. Finally, the method further comprises, for example, using a sending the additional structured text documents to a computer device associated with an editor.

Yet another aspect of the present disclosure is directed to a system for recommending editors for structured text documents. The system comprises, for example, at least one processor, and at least one non-transitory computer readable media storing instructions configured to cause the processor, to for example, convert at least one structured text document stored in a database into one or more vectors, each structured text document having a title, an abstract, and editor information. The processor may also, for example, train a machine learning model to associate the at least one vector with the editor information for that structured text document. The processor may also, for example, receive an additional structured text document, having a title, and an abstract. The processor may also, for example, convert said additional structured text document into one or more vectors. The processor may also, for example, process the one or more vectors of the unpublished structured text documents through the trained machine learning model to identify appropriate editor teams. The processor may also, for example, distribute the additional structured text document to an editor on the appropriate editor team. Finally, the processor may also, for example, send the unpublished structured text documents to a computer device associated with an editor.

### BRIEF DESCRIPTION OF DRAWING(S)

FIG. 1 depicts a system for performing a method of training a machine learning model to recommend editors for additional structured text documents.

FIG. 2 depicts further embodiments of the system from FIG. 1, where the method is used to recommend both an executive editor and associate editor for an additional structured text document.

FIG. 3 depicts a method for distributing workload across a team of editors known as random token distributor based on split ratio.

### DETAILED DESCRIPTION

It is an object of embodiments of the present disclosure to improve the workflow for editors of academic publications. Scientific articles and other similar types of academic works, submitted as structured text documents, require editors to assist with the publication process. It would also be useful to ensure editors are not overworked. Methods are provided for identifying editors and balancing workload across editor teams.

It should be understood that the disclosed embodiments are intended to be performed by a system or similar electronic device capable of manipulating, storing, and transmitting information or data represented as electronic signals as needed to perform the disclosed methods. The system may be a single computer, or several computers connected via the internet or other telecommunications means.

A method includes converting at least one structured text document stored in a database into one or more vectors, each structured text document having a title, an abstract, and editor information. A structured text document may be a draft, a manuscript, a book, an article, a thesis, a dissertation, a monograph, or other working text. An abstract may be a summary, synopsis, digest, precis, or other abridgment of the structured text document. An author may be any number of individuals or organizations. Editor information may include the identities of the editors, or editor teams, of the structured text document. An editor may be one or more persons, other than the author, that reviews or edits the structured text document. Editors may also review and manage the overall editing and revision process for a structured text document. Editors may be associate editors or executive editors. Editors may be associated with teams of editors. A structured text document may also have metadata, such as citations. A person of ordinary skill in the art would understand that a structured text document could take many forms, such as a Word file, PDF, LaTeX, or even raw text.

The system may convert the structured text documents into vectors using a natural language processing algorithm with a vector output. In broad terms, suitable algorithms accept text as input and render a numerical representation of the input text, known as a vector, as output. Suitable natural language processing algorithms include examples such as Doc2Vec, GloVe/PCA projection, BERT, SciBERT, SPECTER, or Universal Sentence Encoder, though a person of ordinary skill in the art may recognize other possible natural language processing algorithms. The system may convert different parts of a structured text document into different types of vectors, while in other embodiments in which some portions of the structured text document are not converted to vectors are also possible. A vector, in some embodiments, can be a mathematical concept with magnitude and direction. In other embodiments, a vector can be a collection of values representing a word's meaning in relation to other words. In yet other embodiments, a vector can be a collection of values representing a text's value in relation to other texts.

Two example embodiments of a vector can be vector 1 with the values (A, B) and vector 2 with the values (C, D) where A, B, C, and D are variables representing any number. One possible measure of distance, the Euclidean distance, between vector 1 and vector 2 is equal to \sqrt{(C−A)²+(D−B)²}. Of course, one skilled in the art can recognize that vectors can have any number of values. One skilled in the art would also recognize measures of distance between vectors beyond the Euclidean distance, such as Manhattan distance or Cosine similarity.

In some embodiments, the structured text document database may be implemented as a collection of training data such as the Microsoft Academic Graph, or may be implemented using any desired collection of structured text documents such as a journal's archive or catalog. The database may be implemented through any suitable database management system such as Oracle, SQL Server, MySQL, PostgreSQL, Microsoft Access, Amazon RDS, HBase, Cassandra, MongoDB, Neo4J, Redis, Elasticsearch, Snowflake, BigQuery, or the like.

In some embodiments the system uses the vectors of the structured text documents, as well as the editors information of each structured text documents, to train a machine learning model to associate the vectors of structured text documents with their editors. The machine-learning model may include, for example, Viterbi algorithms, Naïve Bayes algorithms, neural networks, etc. and/or joint dimensionality reduction techniques (e.g., cluster canonical correlation analysis, partial least squares, bilinear models, cross-modal factor analysis) configured to observe relationships between the vectors of structured text documents and the journals of publication. In some embodiments, training the machine learning model may be a multi-layer deep learning multi-class classifier. In some embodiments, the machine learning model can be retrained periodically with new vectors of structured text document, and editor information. In some embodiments, this retraining may occur for example every two weeks. The retraining may entirely replace the training of the machine learning model, or it may supplement the existing training of the machine learning model.

In some embodiments, system may train the machine learning model to associate the vectors of the structured text documents with the editor teams. For example, if editors E1, E2, and E3 were on editor team 1, the machine learning model will associate all documents edited by E1, E2, and E3 with editor team 1. Grouping editors by teams allows the accumulated training of the machine learning model on departed editors to continue to exist if once an editor retires, changes jobs, is promoted, or otherwise leaves an editor team. To continue the earlier example, if editor E2 retires and is replaced by E4, the machine learning model can continue to use E2's data associate vectors of structured text documents with editor team 1.

In some embodiments the system receives an additional structured text document. The additional structured text document may be received by various means, including electronic submission portal, email, a fax or scan of a physical copy converted into a structured text document through a process such as optical character recognition or similar means, or other means for digital transmission.

In some embodiments, once the system receives the additional structured text document, the system converts the additional structured text document to one or more vectors. Conversion of the additional structured text document into a vector may be accomplished as previously described.

In some embodiments the system uses the one or more vectors of the additional structured text document as an input to the trained machine learning model. The machine learning model, based on its training and vector inputs, outputs an appropriate editor for the additional structured text document.

In some embodiments, the machine learning model, based on its training and vector inputs, outputs an appropriate editor team for the additional structured text document.

In some embodiments, the system may output an executive editor or executive editor team, as well as an associate editor or editor team. Teams of editors may be hierarchical in nature or may not be. Editor teams that are hierarchical in nature each report to one executive editor; non-hierarchal teams do not have editor teams reporting each reporting to one executive editor.

In some embodiments, the machine learning model does not output a single appropriate editor or editor team. Instead, the machine learning model outputs confidence scores for various editor teams. Confidence scores, in some embodiments, may be numeric values that represent the machine learning model's prediction that a given editor team is the proper team to edit, or otherwise revise, the additional structured text document. In some embodiments, confidence scores are softmax values, where the sum of all assigned confidence scores for an additional structured text documents sums to 1.00. For example, given an additional structured text document, the machine learning model may calculate a confidence score for editor team 1 of 0.85, a confidence score for editor team 2 of 0.09, and a confidence score for team 3 of 0.03. In this example, the machine learning model is 85% confident the additional structured text document should be edited by an editor on team 1.

In some embodiments, the machine learning model calculates executive editor confidence scores by aggregating the confidence scores for each executive editor associated with one or more editor team. The system then ranks the executive editors by aggregate score and distributes the additional structured text document to the executive editor with the highest score. For example, if the machine learning model calculated confidence scores for five associate editor teams as follows:

Associate Editor Team 1 0.4234 (reports to Executive Editor 1)

Associate Editor Team 2 0.2436 (reports to Executive Editor 2)

Associate Editor Team 3 0.2131 (report Executive Editor 2)

Associate Editor Team 4 0.1234 (report Executive Editor 3)

Associate Editor Team 5 0.0944 (report Executive Editor 3)

The system assigns Associate Editor Team 1's score to Executive Editor 1, resulting in Executive Editor 1 having a score of 0.4234. The system assigns Associate Editor Team 2's and Associate Editor 3's scores to Executive Editor 2, resulting in Executive Editor 2 having a score of 0.4567. The system assigns Associate Editor Team 4's and Associate Editor Team 5's scores to Executive Editor 3, resulting in Executive Editor 3 having a score of 0.2178. The system would rank Executive Editor 2 first, then Executive Editor 1, and Executive Editor 3 last. The additional structured text document would be distributed to Executive Editor 2 because Executive Editor 2's score of 0.4567 is the highest executive editor confidence score.

In some embodiments, a second machine learning model is trained to generate recommendations for executive editors or executive editor teams, separate from a first machine learning model trained to recommend associate editors or associate editor teams. The system submits the vectors of the additional structured text document to both the first and second trained machine learning models.

In some embodiments, the machine learning model may be trained to suggest a team of editors instead of a single editor. In some embodiments, this includes the system assigning the additional structured text document to an editor on that team. This assignment may be done based on distribution based on workload or may be done using random token distributor based on split ratio, or any other suitable method.

In embodiments where the machine learning model recommends teams of editors, the system then distributes the additional structured text document to an editor on that team. The distribution can be done randomly, or can be done so as to balance editor workload.

In some embodiments, distributing additional structured text documents so as to balance editor workload can do done with random token distributor based on split ratio. Random token distributor based on split ratio includes the system assigning each editor on a team a fixed number of digital tokens, then storing those tokens in a queue. When the machine learning model assigns a structured text document to the editor team, the system randomly picks a token from the queue, sends the structured text document to that editor's computer device, and then removes that token from the queue.

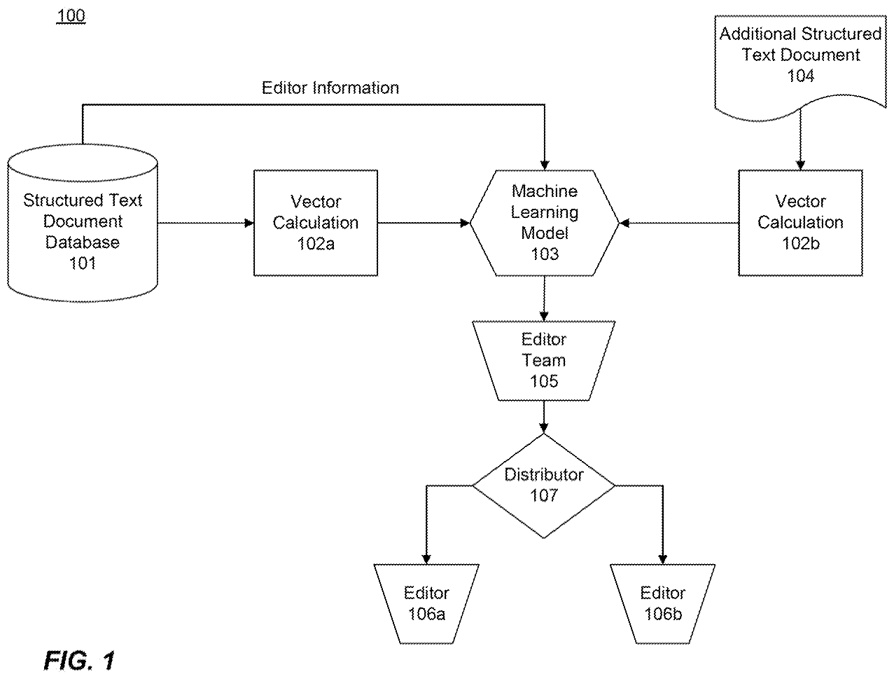

FIG. 1 shows a schematic block diagram 100 of a system for performing the disclosed exemplary embodiment of a method including computerized systems for recommending editors. In some embodiments, system 100 includes structured text document database 101, vector calculations 102a, and 102 b, machine learning model 103, additional structured text document 104, editor team 105, distributor 107, and editors 106a and 106b.

In some embodiments, system 100 should be understood as a computer system or similar electronic device capable of manipulating, storing, and transmitting information or data represented as electronic signals as needed to perform the disclosed methods. System 100 may be a single computer, or several computers connected via the internet or other telecommunications means.

A method includes converting at least one structured text document stored in a database 101 into one or more vectors, each structured text document having a title, an abstract, and editor information. A structured text document may be a draft, a manuscript, a book, an article, a thesis, a dissertation, a monograph, or other working text. An abstract may be a summary, synopsis, digest, precis, or other abridgment of the structured text document. An author may be any number of individuals or organizations. Editor information may include the identities of the editors, or editor teams, of the structured text document. An editor may be one or more persons, other than the author, that reviewed or edited the structured text document. Editors may be associate editors or executive editors. Editors may be associated with teams of editors. A structured text document may also have metadata, such as citations. A person of ordinary skill in the art would understand that a structured text document could take many forms, such as a Word file, PDF, LaTeX, or even raw text.

In some embodiments, vector calculations 102 and 102b may be implemented by system 100 using a natural language processing algorithm with a vector output. In some embodiments, vector calculations 102a and 102b are processes stored on the medium operated by the processor. In broad terms, suitable algorithms accept text as input and render a numerical representation of the input text, known as a vector, as output. Suitable natural language processing algorithms include examples such as Doc2Vec, GloVe/PCA projection, BERT, SciBERT, SPECTER, or Universal Sentence Encoder, though a person of ordinary skill in the art may recognize other possible natural language processing algorithms. The system may convert different parts of a structured text document into different types of vectors, while in other embodiments in which some portions of the structured text document are not converted to vectors are also possible. A vector, in some embodiments, can be a mathematical concept with magnitude and direction. In other embodiments, a vector can be a collection of values representing a word's meaning in relation to other words. In yet other embodiments, a vector can be a collection of values representing a text's value in relation to other texts.

In some embodiments, the structured text document database 101 may be implemented as a collection of training data, such as the Microsoft Academic Graph, or may be implemented using any desired collection of structured text documents such as a journal's archive or catalog. The database may be implemented through any suitable database management system such as Oracle, SQL Server, MySQL, PostgreSQL, Microsoft Access, Amazon RDS, HBase, Cassandra, MongoDB, Neo4J, Redis, Elasticsearch, Snowflake, BigQuery, or the like.

In some embodiments the system 100 uses the vectors of the structured text documents, as well as the editor information of each structured text documents, to train a machine learning model 103 to associate the vectors of structured text documents with their editors. In some embodiments, the machine learning model 103 can be trained with vector representations of the title, abstract, full text, or metadata of the structured text documents. In some embodiments, machine learning model 103 is a process or processes stored on the medium operated by the processor. The machine-learning model 103 may include, for example, Viterbi algorithms, Naïve Bayes algorithms, neural networks, etc. and/or joint dimensionality reduction techniques (e.g., cluster canonical correlation analysis, partial least squares, bilinear models, cross-modal factor analysis) configured to observe relationships between the vectors of structured text documents and the journals of publication. In some embodiments, training the machine learning model may be a multi-layer deep learning multi-class classifier. In some embodiments, the machine learning model can be retrained periodically with new vectors of structured text document, and editor information. In some embodiments, this retraining may occur for example every two weeks. The retraining may entirely replace the training of the machine learning model, or it may supplement the existing training of the machine learning model 103.

In some embodiments, system 100 may train the machine learning model 103 to associate the vectors of the structured text documents with the editor teams. For example, if editors E1, E2, and E3 were on editor team 1, the machine learning model will associate all documents edited by E1, E2, and E3 with editor team 1.

In some embodiments the system receives an additional structured text document 104. The additional structured text document 104 may be received by various means, including electronic submission portal, email, a fax or scan of a physical copy converted into a structured text document through a process such as optical character recognition or similar means, or other means for digital transmission.

In some embodiments, once the system receives the additional structured text document 104, the system converts the additional structured text document 104 to one or more vectors using vector conversion 102b. Conversion of the additional structured text document into a vector may be accomplished as previously described for vector conversion 102a.

In some embodiments the system uses the one or more vectors of the additional structured text document 104 as an input to the trained machine learning model 103. The machine learning model, based on its training and vector inputs, outputs an appropriate editor team 105 for the additional structured text document.

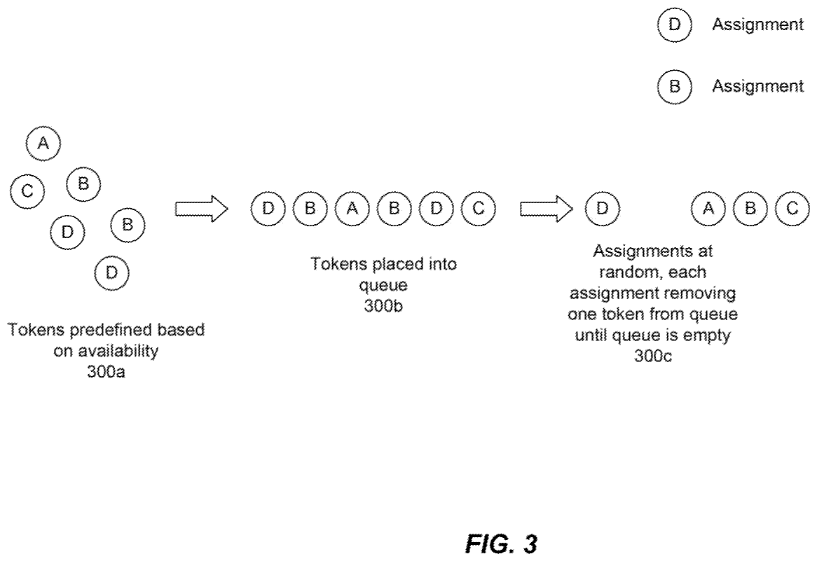

In some embodiments, the system 100 then assigns the additional structured text document 104 to one or more editors 106a, 106b, on editor team 105, using distributor 107. In some embodiments, distributor 107 is a process or processes stored on the medium operated by the processor. In some embodiments, distributor 107 assigns additional structured text documents to an editor on an editor team 105, or using random token distributor based on split ratio (as shown in FIG. 3), or any other suitable method.

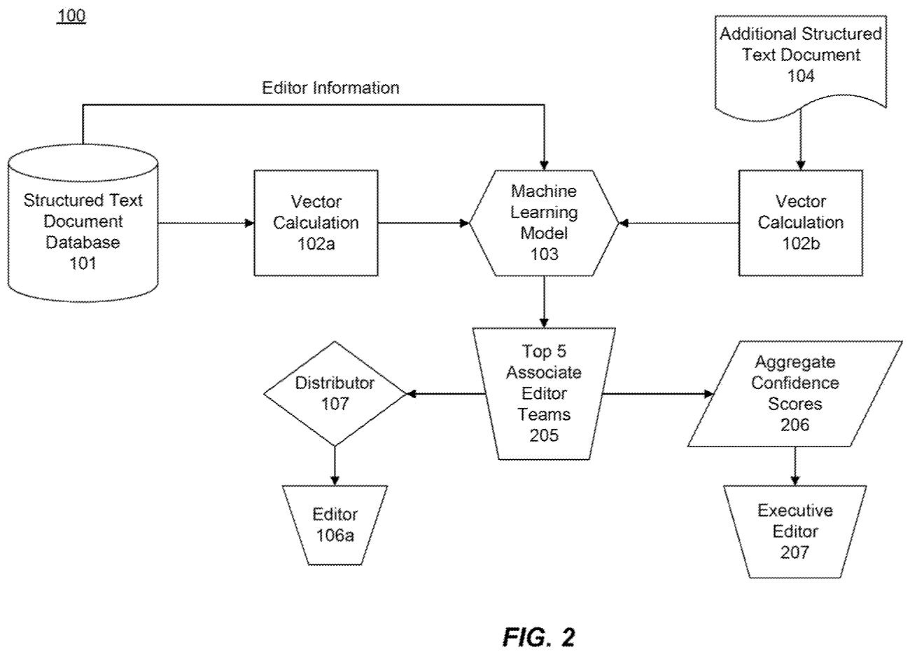

Referring now to FIG. 2, further embodiments of system 100 are shown for performing the disclosed exemplary embodiment of a method including computerized systems for recommending editors. In some embodiments, system 100 includes structured text document database 101, vector calculation 102, machine learning model 103, additional structured text document 104, distributor 107, editor 106a, top five associate editor teams 205, aggregate confidence scores 206, and executive editor 207.

In some embodiments, the system may output an executive editor or executive editor team 207, as well as an associate editor or editor team. Teams of editors may be hierarchical in nature or may not be. Editor teams that are hierarchical in nature each report to one executive editor; non-hierarchal teams do not have editor teams reporting each reporting to one executive editor.

In some embodiments, the machine learning model calculates executive editors confidence scores by aggregating the confidence scores 206 for each executive editor associated with one or more editor team 205. The system then ranks the executive editors by aggregate score and distributes the additional structured text document to the executive editor with the highest score 207. For example, if the machine learning model calculated confidence scores for five associate editor teams 205 as follows:
Associate Editor Team 1: 0.4234 (reports to Executive Editor 1)
Associate Editor Team 2: 0.2436 (reports to Executive Editor 2)
Associate Editor Team 3: 0.2131 (report Executive Editor 2)
Associate Editor Team 4: 0.1234 (report Executive Editor 3)
Associate Editor Team 5: 0.0944 (report Executive Editor 3)
   The system assigns Associate Editor Team 1's score to Executive Editor 1, resulting in Executive Editor 1 having a score of 0.4234. The system assigns Associate Editor Team 2's and Associate Editor Team 3's scores to Executive Editor 2, resulting in Executive Editor 2 having a score of 0.4567. The system assigns Associate Editor Team 4's and Associate Editor Team 5's scores to Executive Editor 3, resulting in Executive Editor 3 having a score of 0.2178. The system would rank Executive Editor 2 first, then Executive Editor 1, and Executive Editor 3 last. The additional structured text document would be distributed to Executive Editor 2 because Executive Editor 2's score of 0.4567 is the highest executive editor confidence score.

Referring now to FIG. 3, a method is shown, the method being for distributing work among an editor team using random token distributor based on split ratio. In some embodiments, the method can be performed by the system 100 of FIG. 1 or FIG. 2 as part of distributor 107. In step 300a, each editor on team, editors A, B, C and D, are assigned a fixed number of digital tokens, based on their availability to take on more work. For example, if editor A is already working on a particularly large or challenging assignment, and editor C is part-time, both editors A and C may be assigned fewer tokens than editors B and D, ensuring A and C will receive less additional work than B and D. In some embodiments, availability may be set by each editor individually, by an editor's executive editor or other manager, or may be tracked by the system performing the method in FIG. 3, or by any other appropriate method. In some embodiments, availability is updated periodically.

In step 300b, these tokens are stored in a queue. In some embodiments, the queue may be a array or other means of storing the number of tokens on the medium operated by the processor performing the method of FIG. 3.

In step 300c, performed, for example by 107 in FIGS. 1 and 2, when the editor team is recommended for an additional structured text document, a token is randomly picked from the from the queue, and that editor is assigned to edit the additional structured text document. Randomly picking a token from the queue may be accomplished by any suitable method, for example, the random function of any suitable programming language.

In some embodiments, randomization of token order may happen at step 300b. For example, the queue may be a First-in-First-Out list, array, or other data structure, into which the tokens are placed in a random order. Randomizing the tokens into the queue may be accomplished by any suitable method, for example, the random function of any suitable programming language. Then, at step 300c, the tokens are removed from the queue in first-in-first-out order, and as each token is removed from the queue, that editor is assigned to edit the additional structured text document.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

While illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Python, Java, C/C++, Objective-C, Swift, HTML, HTML/AJAX combinations, XML, or HTML with included Java applets.

What is claimed is:

1. A method comprising:
converting at least one structured text document stored in a database into one or more vectors, each structured text document having a title, an abstract, and editor information;
training a machine learning model to associate the at least one vector with the editor information for that structured text document;
receiving an additional structured text document, having a title, and an abstract;
converting said additional structured text document into one or more vectors;
processing the one or more vectors of the additional structured text document through the trained machine learning model to identify appropriate editor teams;
distributing the additional structured text document to an editor on the appropriate editor team; and
sending the additional structured text document to a computer device associated with the editor on the appropriate editor team.

2. The method of claim 1, wherein:
the at least one structured text document stored in a database has a title, an abstract, a full text, and editor information;
the additional structured text document has a title, and an abstract, and a full text.

3. The method of claim 1, wherein:
the at least one structured text document stored in a database has a title, an abstract, metadata, and editor information;
the additional structured text document has a title, and an abstract, and metadata.

4. The method of claim 1, wherein:
the at least one structured text document stored in a database has a title, an abstract, a full text, metadata, and editor information;
the additional structured text document, has a title, and an abstract, full text, and metadata

5. The method of claim 1, wherein:
the trained machine learning model identifies appropriate editor teams using confidence scores.

6. The method of claim 5, wherein:
the editor teams have associate editors and executive editors, each editor team being associated with one executive editor;
calculating confidence scores for executive editors by aggregating the confidence scores for each executive editor associated with one or more appropriate editor team;
sending the unpublished structured text documents to a computer device associated with executive editor with the highest aggregate confidence score.

7. The method of claim 1, further comprising
converting at least one structured text document stored in a database into one or more vectors, each structured text document having a title, an abstract, and executive editor information;
training a machine learning model to associate the at least one vector with the executive editor information for that structured text document;
receiving an additional structured text document, having a title, and an abstract;
converting said additional structured text document into one or more vectors;
processing the vector of the additional structured text document through the trained machine learning model to identify appropriate executive editor teams;
distributing the additional structured text document to an editor on the appropriate executive editor team; and
sending the additional structured text document to a computer device associated with the executive editor on the appropriate executive editor team.

8. The method of claim 7, wherein:
the at least one structured text document stored in a database has a title, an abstract, a full text, and executive editor information;
the additional structured text document has a title, and an abstract, and a full text.

9. The method of claim 7, wherein:
the at least one structured text document stored in a database has a title, an abstract, metadata, and executive editor information;
the additional structured text document has a title, and an abstract, and metadata.

10. The method of claim 7, wherein:
the at least one structured text document stored in a database has a title, an abstract, a full text, metadata, and executive editor information;
the additional structured text document, has a title, and an abstract, full text, and metadata.

11. The method of claim 7, wherein:
the trained machine learning model identifies appropriate executive editor teams using confidence scores.

12. The method of claim 1, further comprising
distributing the additional structured text document to an editor on the appropriate editor team so as to balance editor workload.

13. The method of claim 1, further comprising
distributing the additional structured text document to an executive editor on the appropriate executive editor team so as to balance executive editor workload.

14. The method of claim 12, wherein:
editor workload is balanced by assigning editors tokens based on editor workload;
editor tokens of all editors on a team are aggregated into a queue;
when distributing an additional structured text document to an editor on a team, one token is removed at random from that team's queue and the additional structured text document is distributed to the editor whose token was removed; and
queues are re-initialized with new tokens when depleted.

15. The method of claim 13, wherein:
executive editor workload is balanced by assigning executive editors tokens based on editor workload;
executive editor tokens of all editors on a team are aggregated into a queue;
when distributing an additional structured text document to an executive editor on a team, one token is removed at random from that team's queue and the additional structured text document is distributed to the executive editor whose token was removed; and
queues are re-initialized with new tokens when depleted.

16. A system for identifying appropriate editors for structured text documents, comprising:
at least one processor, and
At least one non-transitory computer readable media storing instructions configured to cause the processor to:
convert at least one structured text document stored in a database into one or more vectors, each structured text document having a title, an abstract, and editor information;
train a machine learning model to associate the at least one vector with the editor information for that structured text document;
receive an additional structured text document, having a title, and an abstract;
convert said additional structured text document into one or more vectors;
process the vectors of the additional structured text document through the trained machine learning model to identify appropriate editor teams;
distribute the additional structured text document to an editor on the appropriate editor team; and
send the additional structured text document to a computer device associated with the editor on the appropriate editor team.

17. The system of claim 16, wherein:
the at least one structured text document stored in a database has a title, an abstract, a full text, and editor information;
the additional structured text document has a title, and an abstract, and a full text.

18. The system of claim 16, wherein:
the at least one structured text document stored in a database has a title, an abstract, metadata, and editor information;
the additional structured text document has a title, and an abstract, and metadata.

19. The system of claim 16, wherein:
the at least one structured text document stored in a database has a title, an abstract, a full text, metadata, and editor information;
the additional structured text document, has a title, and an abstract, full text, and metadata

20. The system of claim 16, wherein:
the trained machine learning model identifies appropriate editor teams using confidence scores.

21. The method of claim 20, wherein:
the editor teams have associate editors and executive editors, each editor team being associated with one executive editor;
The at least one non-transitory memory storing instructions is further configured to cause the processor to:
calculate confidence scores for executive editors by aggregating the confidence scores for each executive editor associated with one or more appropriate editor team;
rank the executive editors by calculated confidence scores; and
send the unpublished structured text documents to a computer device associated with executive editor with the highest aggregate confidence score.

22. The system of claim 16, wherein:
The at least one non-transitory computer readable media storing instructions is further configured to cause the processor to:
convert at least one structured text document stored in a database into one or more vectors, each structured text document having a title, an abstract, and executive editor information;
train a machine learning model to associate the at least one vector with the executive editor information for that structured text document;
receive an additional structured text document, having a title, and an abstract;
convert said additional structured text document into one or more vectors;
process the vector of the additional structured text document through the trained machine learning model to identify appropriate executive editor teams;
distribute the additional structured text document to an editor on the appropriate executive editor team; and
send the additional structured text document to a computer device associated with the executive editor on the appropriate executive editor team

23. The system of claim 22, wherein:
the at least one structured text document stored in a database has a title, an abstract, a full text, and executive editor information;
the additional structured text document has a title, and an abstract, and a full text.

24. The system of claim 22, wherein:
the at least one structured text document stored in a database has a title, an abstract, metadata, and executive editor information;
the additional structured text document has a title, and an abstract, and metadata.

25. The system of claim 22, wherein:
the at least one structured text document stored in a database has a title, an abstract, a full text, metadata, and executive editor information;
the additional structured text document, has a title, and an abstract, full text, and metadata

26. The system of claim 22, wherein:
the trained machine learning model identifies appropriate executive editor teams using confidence scores

27. The system of claim 16, further comprising
distributing the additional structured text document to an editor on the appropriate editor team so as to balance editor workload.

28. The system of claim 22, further comprising
distributing the additional structured text document to an executive editor on the appropriate executive editor team so as to balance executive editor workload.

29. The system of claim 27, wherein:
editor workload is balanced by assigning editors tokens based on editor workload;
editor tokens of all editors on a team are aggregated into a queue;
when distributing an additional structured text document to an editor on a team, one token is removed at random from that team's queue and the additional structured text document is distributed to the editor whose token was removed; and
queues are re-initialized with new tokens when depleted.

30. The system of claim 28, wherein:
executive editor workload is balanced by assigning executive editors tokens based on editor workload;
executive editor tokens of all editors on a team are aggregated into a queue;
when distributing an additional structured text document to an executive editor on a team, one token is removed at random from that team's queue and the additional structured text document is distributed to the executive editor whose token was removed; and
queues are re-initialized with new tokens when depleted.
